(19) United States
(12) Patent Application Publication
(10) Pub. No.: US 2024/0341530 A1
(43) Pub. Date: Oct. 17, 2024

(54) BASKET RELOAD SYSTEM

(71) Applicant: Lab2Fab, LLC, Fremont, CA (US)

(72) Inventor: Samuel Lewis Tanaka, San Leandro, CA (US)

(21) Appl. No.: 18/627,569

(22) Filed: Apr. 5, 2024

Related U.S. Application Data
(60) Provisional application No. 63/459,299, filed on Apr. 14, 2023.
(60) Provisional application No. 63/531,779, filed on Aug. 9, 2023.

(51) Int. Cl. A47J 37/12; A23L 5/10; A47J 27/14; B25J 11/00

(52) U.S. Cl. CPC A47J 37/1228; A23L 5/11; A47J 27/14; A47J 37/1295; B25J 11/0045

(57) ABSTRACT

Example methods and systems are directed to moving a quantity of a bulk food item within an automated cooking system. A quantity of the bulk food item may be provided from a bulk food dispenser. The quantity of the bulk food item may be received at a lower transfer component from the bulk food dispenser. The quantity of the bulk food item may be transferred from the lower transfer component to a dump bin at a first location. The dump bin may move vertically from the first location to a second location above the first location. The quantity of the bulk food item may be provided or dispensed to the automated cooking system while the dump bin is located at the second location.

### CROSS-REFERENCE TO RELATED APPLICATIONS

This application claims the benefit of U.S. Provisional Patent Application No. 63/459,299 filed Apr. 14, 2023, and U.S. Provisional Patent Application No. 63/531,779 filed Aug. 9, 2023, and the disclosures of each are hereby incorporated by reference herein in their entireties for all purposes.

### INTRODUCTION

The present disclosure is directed to apparatuses, systems, and methods for dispensing consumable items, and more particularly, to apparatuses, systems and methods that move a stored consumable item from a storage area to a dispensing area.

### BACKGROUND

Robotic automated food preparation systems have been developed for automating various kitchen operations of a restaurant. For example, each of U.S. patent application Ser. No. 17/494,664 (filed on Oct. 5, 2021) and U.S. Provisional Patent Application Ser. No. 63/088,162 (filed on Oct. 6, 2020) disclose examples of robotic automated food preparation systems that may be used to fry consumable items such as French fries, onion rings, chicken, and other related consumable items.

In some robotic automated fryer systems, a robotic arm may be employed to move consumable items from a storage container or cabinet to a cooking medium, e.g., of a fryer. Consumable items may be initially stored in a cabinet, freezer, or other storage device, and measured out or metered for cooking. Storage containers may dispense the consumable items at a relatively low position relative to cooking devices such as fryers, particularly where gravity-based dispensing mechanisms are employed. The relative difference in vertical position increases the number and/or degree of robot movements necessary to move dispensed consumable items from a storage container to a cooking device, increasing the time required for retrieving consumable items from storage as well as overall cooking time associated with the consumable items.

### SUMMARY

In at least some example approaches, a method for moving a quantity of a bulk food item within an automated cooking system comprises providing, from a bulk food dispenser, the quantity of the bulk food item. The method further includes receiving, at lower transfer component and from the bulk food dispenser, the quantity of the bulk food item, and transferring the quantity of the bulk food item from the transfer component to a dump bin at a first location. The method further comprises moving the dump bin vertically from the first location to a second location above the first location, and providing the quantity of the bulk food item to the automated cooking system while the dump bin is located at the second location.

In at least some example illustrations, a bulk food dispensing system comprises a bulk food dispenser configured to store a bulk food item, and a dispenser configured to dispense a quantity of the bulk food item from the bulk food dispenser. The system also includes a lower transfer component configured to receive the quantity of the bulk food item from the dispenser and transfer the quantity of the bulk food item laterally away from the dispenser. Additionally, the system comprises a dump bin configured to receive the quantity of the bulk food item from the lower transfer component at a first location. The dump bin may be configured to move vertically from the first location to a second location above the first location. The dump bin may also be configured to provide the quantity of the bulk food item to an automated cooking system while the dump bin is located at the second location.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1 depicts a perspective view of a bulk food dispensing system, in accordance with some embodiments of the disclosure;

FIG. 2A depicts a perspective view of the bulk food dispenser of FIG. 1, with a dump bin in a first position, in accordance with some embodiments of the disclosure;

FIG. 2B depicts a perspective view of the bulk food dispenser of FIG. 2A, with the dump bin in a second position elevated relative to the first position, in accordance with some embodiments of the disclosure;

FIG. 3A depicts the dump bin of FIGS. 1, 2A, and 2B detached from the bulk food dispensing system and shown with an upper deflector attached to the dump bin;

FIG. 3B depicts the dump bin of FIG. 3A with the upper deflector detached from the dump bin;

FIG. 4A depicts a perspective view of the bulk food dispenser of FIG. 1, with a plurality of baskets positioned on respective basket holders and a dump bin in the first position, in accordance with some embodiments of the disclosure;

FIG. 4B depicts an enlarged perspective view of the baskets of FIG. 4A and their respective basket holders, in accordance with some embodiments of the disclosure;

FIG. 5 depicts a front view of another bulk food dispensing system with a lower transfer component comprising a pusher, in accordance with some embodiments of the disclosure;

FIG. 6 depicts a front view of another bulk food dispensing system with a lower transfer component comprising a paddle conveyor, in accordance with some embodiments of the disclosure;

FIG. 7 depicts a front view of a bulk food dispensing system comprising multiple bulk food dispensers, in accordance with some embodiments of the disclosure;

FIG. 8 depicts a perspective view of a dispensing system configured to dispense quantities of a bulk food item to an automated cooking system, in accordance with some embodiments of the disclosure; and

FIG. 9 is a flow chart representing an illustrative method of dispensing quantities of a bulk food item, in accordance with some embodiments of the disclosure.

### DETAILED DESCRIPTION

Example illustrations herein are generally directed to systems and methods that provide automated food preparation (e.g., as executed by at least one robotic apparatus) including handling of fryer baskets using a robotic arm. Example automated systems described herein facilitate the safe, clean, cost-effective, and timely performance of bulk or specialized food preparation operations by utilizing robotic equipment and other automated features to perform food preparation operations that may otherwise create substantial issues of operator safety, ergonomics, and cleanliness. Although the present disclosure is described in the context of an automated frying system facilitated with one or more robot arms, the reload system described in the present disclosure may be utilized with other automated components to perform other food preparation operations.

A bulk dispenser may have a standard or designed dispensing location. For example, a bulk food dispenser may include one or more hoppers that are stored within an area that has particular operating conditions, such as a refrigerated, frozen, or an otherwise controlled temperature and humidity environment. The bulk food items may be fed via gravity, e.g., with dispensing facilitated by a component such as a plunger or an auger. In order to store a large quantity of food items to be dispensed within a typically crowded space such as the back-of-house food preparation area of a restaurant while taking advantage of the gravity feed, the bulk dispenser may dispense the food item relatively close to the ground, with dispensing being performed when a user places an appropriate container (e.g., a basket or other container) below the dispenser (e.g., as sensed by one or more sensors) or when the user manually requests that the item is dispensed. In the context of a human operated system, repeatedly accessing relatively heavy items at a location close to the floor may be ergonomically undesirable and could cause injury.

Moreover, lengthy transfer times from such a location, or excessive time at rest in the back-of-house environment between dispensing and process, may result in non-ideal conditions for food cooking and processing. For example, food that is being stored in a frozen, refrigerated, heated, or other controlled condition may begin to approach room temperature, which may reduce the efficacy of controlled cooking operations that were intended to be performed in a particular manner (e.g., frozen goods in frying systems). In examples of the present disclosure, a food item to be cooked may be dispensed and staged in a manner such that the food items remain at the desired temperature for the subsequent automated operations.

In some example automated cooking systems, a robotic frying system may receive quantities of a bulk food item from a dispensing system. For example, a robotic arm may be located proximate to a bulk dispenser, a fryer, and a staging location for cooked food items. Examples of such systems are described in the patent applications incorporated by reference herein, such as U.S. patent application Ser. No. 17/494,664 (filed on Oct. 5, 2021), U.S. patent application Ser. No. 18/096,388 (filed Jan. 12, 2023), and U.S. patent application Ser. No. 18/098,437 (filed Jan. 18, 2023). While the frying and staging areas are located at a similar height relative to a floor surface, accessing the location of dispensing requires a substantial horizontal and vertical movement.

Some embodiments of this disclosure employ an automated basket reload system to avoid an automated component such as a robotic arm having to repeatedly make large vertical movements to access the food item being dispensed. The dispenser is automated to correctly dispense a desired amount of the item to be fried to a dispense and transfer area that automatically and reliably provides the dispensed food items to a dump bin, for example, utilizing gravity, plungers, a conveyor, and the like to transfer the dispensed food items horizontally to the dump bin. The dump bin is fixed to a side of the dispenser and is able to traverse vertically at a relatively high speed once it is loaded with the food items. The dump bin traverses vertically to a location for dispensing to automated cooking equipment, for example, where a fry basket is located such as based on being held at a location by a robotic arm or placed there by a robotic arm to receive the food items. Dispensing is performed via actuating the dump bin to its dump configuration, for example, by mechanical features which cause a portion of the dump bin to open and the dump bin to orient itself appropriately.

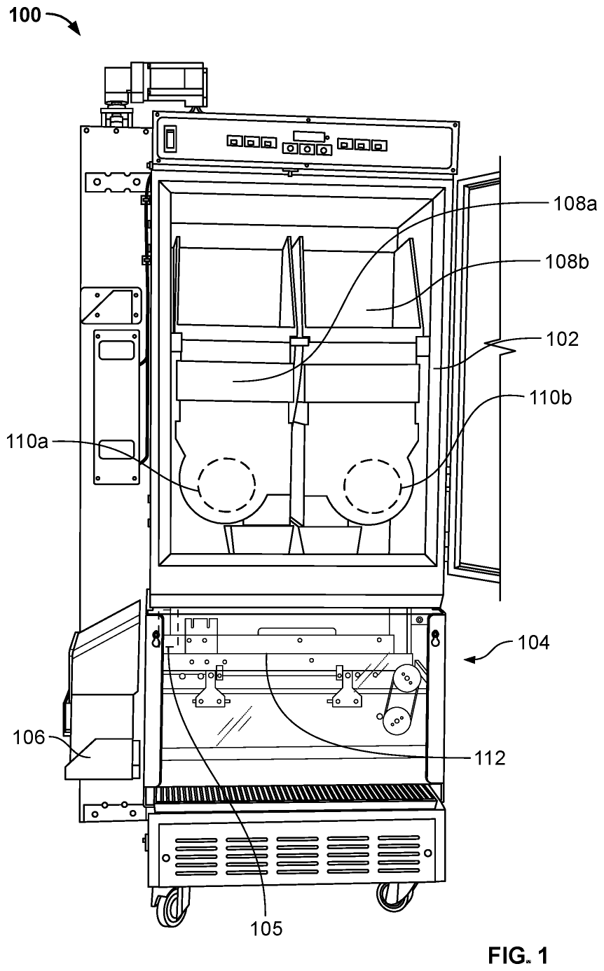

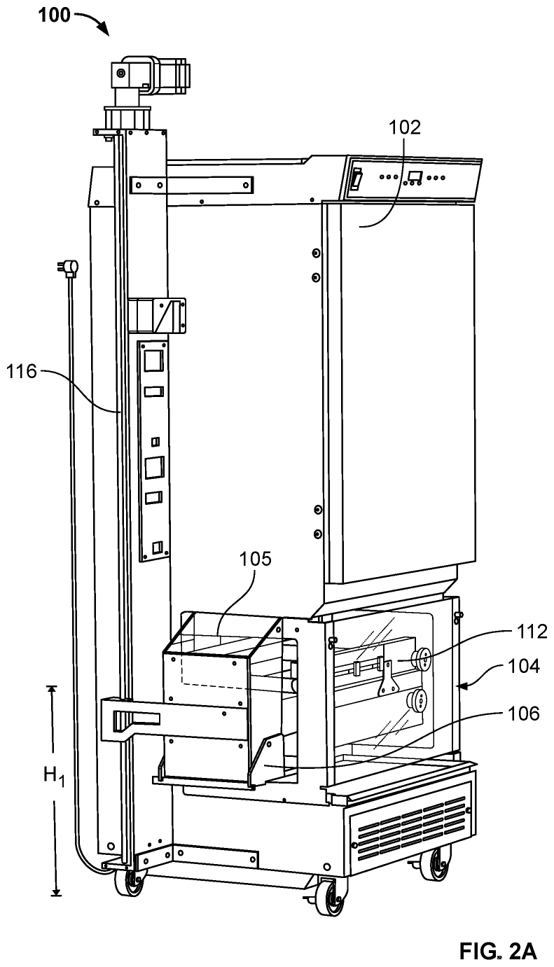

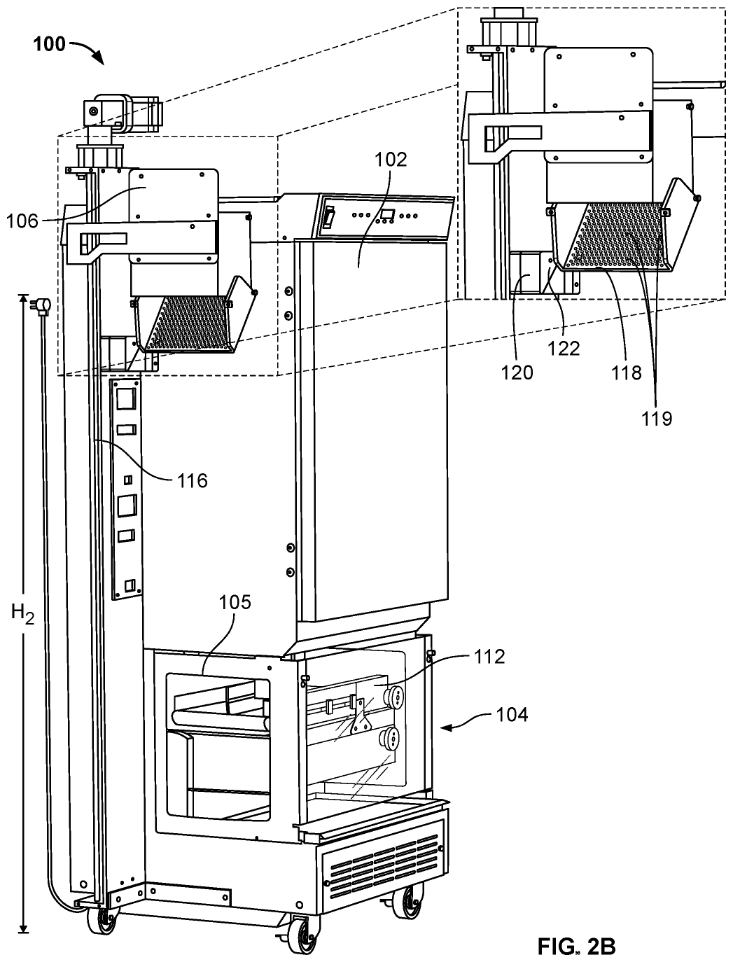

Referring now to FIGS. 1, 2A, and 2B, an example bulk food dispensing system 100, e.g., for dispensing quantities of bulk food items to an automated cooking system, is illustrated and described in further detail. Generally, the dispensing system 100 provides a quantity of consumable bulk food items at an elevated position relative to a gravity-based dispenser 102 of the system 100. The system 100 may thereby increase throughput of an associated automated cooking system, e.g., by decreasing time needed of a robotic arm of the system to collect dispensed quantities of a bulk food item.

Although the present disclosure is described in the context of fryer baskets and dispensing bulk food items into the same, it will be understood that this disclosure may similarly be applied to bulk dispensing into other containers or vessels. In the example illustrated in FIGS. 1, 2A, and 2B, the dispenser 102 includes a plurality of hoppers 108a, 108b (collectively, 108), with each hopper 108 configured to store respective bulk food items (e.g., for frozen goods). However, different numbers of hoppers may be utilized in different examples. In some examples, multiple hoppers 108 may include the same food item to facilitate prompt dispensing by preparing one hopper for dispensing while the other hopper is actively dispensing. In some embodiments, different food items may be located in different hoppers 108, and the dispensing and selection of food items may be selectively controlled based on customer orders, for example, as described in U.S. patent application Ser. No. 16/780,797, which is incorporated by reference in its entirety. Although the present disclosure may describe examples in which a single type of food item is dispensed, it will be understood that modifications may be performed to facilitate the selective dispensing of multiple food items from hoppers 108 of a single bulk dispenser 102, such as based on availability of fryers (e.g., such that similar items are fried in the same frying oil), customer orders, and the like.

As will be described further below, example bulk food items may include any consumable items that are convenient for processing or cooking in an automated cooking system and/or are typically served in portions comprising multiple consumable items. Merely as examples, consumable items herein may be French fries, onion rings, mozzarella sticks, fried vegetables, chicken tenders, or chicken nuggets. Further, as noted above in at least some examples the bulk food items may typically be suited for frying, i.e., by submerging in heated oil or another cooking medium. Generally, the bulk food dispenser 102 may store consumable items in a refrigerated or freezer environment, as may be convenient for maintaining such example consumable items in a condition, e.g., frozen, thereby facilitating storage of the bulk food item within the dispenser 102 and allowing for dispensing of a quantity of the bulk food item on demand.

Furthermore, as will be described further below in some examples multiple dispensers 102 may be employed to facilitate storing and dispensing additional bulk food items. Accordingly, an automated cooking system may employ dispensing system 100 to selectively provide different types or amounts of bulk food items. For example, an instruction may be provided to the system 100 to dispense a desired quantity of a bulk food item stored in one of the hoppers 108, e.g., a desired weight or volume of the bulk food item. In response, an associated dispenser 102 of multiple dispensers 102 may dispense the bulk food item in the instructed or desired quantity.

As noted above, the dispenser 102 may generally store and dispense bulk food items in a refrigerated or frozen environment suitable for storage of bulk food items. In the illustrated examples, the hoppers 108 are located within a temperature-controlled environment within the dispenser 102. The temperature-controlled environment in examples herein is relatively colder than a room-temperature environment, for example, below or close to a freezing temperature. Any suitable temperature-controlled environment may be provided by the dispenser 102 as appropriate for a given bulk food item, and in some cases the temperature-controlled environment may be heated otherwise kept relatively warmer than room temperature.

Bulk food items contained within hoppers 108 may be dispensed vertically downward in a variety of ways, such as by an auger, paddlewheel, plunger, or the like, to assist and facilitate the gravity feed of a desired amount of the food item to be dispensed. Dispensing mechanisms such as an auger or paddlewheel may generally allow bulk food items or frozen products in general to be declumped and/or singulated to facilitate a precise granular control of the dispensed bulk food items. The declumping or singulating of bulk food items by example dispensing mechanisms may facilitate metering of a desired weight of the bulk food items. In the illustrated examples, the hopper 108a has a screw-type dispenser or auger 110a within the hopper 108a. Similarly, the hopper 108b has an auger 110b. The augers 110 are configured to turn to break apart and facilitate dispensing of a desired quantity of a bulk food item from the respective hopper 108, allowing the quantity of the bulk food item to drop down below to a lower transfer component 104. The hoppers 108 may allow bulk food items to fall down via gravity onto and from the augers 110. Accordingly, a gravity-based feed may be employed in each of the hoppers 108 to bring bulk food items to the auger 110. Rotation of the auger 110 may cause movement of the bulk food items vertically downward and horizontally to a dispensing location within the hopper 108, e.g., pushing the bulk food items to an opening in the hopper 108 and allowing the bulk food item to drop onto the lower transfer component 104. The motion of the auger may be controlled in accordance with an appropriate amount of the bulk food items to be distributed. For example, an instruction from an automated cooking system may be converted to a rotational amount or travel distance of the auger 110. The auger 110 may then execute the rotational amount, thereby dispensing the desired amount of the bulk food item.

The lower transfer component 104 is configured to receive a quantity of the bulk food item from the hopper 108, and to laterally transport the quantity of the bulk food item to a dump bin 106. In the example illustrated in FIGS. 1 and 2A, the lower transfer component 104 include a conveyor 112 that carries bulk food items laterally or horizontally from a position beneath the hoppers 108 to an aperture 105. The bulk food items are received in the dump bin 106 after being dispensed through the aperture 105 by the conveyor 112. The movement of the conveyor may be controlled in a variety of ways, such as based on a known or estimated amount of food dispensed from the hopper(s) 108 (e.g., based on the movement of a feed mechanism such as an auger, or the volume of a dispensing volume), the weight of items on the conveyor, or indirect sensing of the quantity of a dispensed item on the conveyor.

Although FIGS. 1, 2A, and 2B depict a single reload area, e.g., via aperture 105 to the left side of the dispenser 102, a reload area or opening may be located at multiple locations, such as any side or as an attachment to the front door of the bulk dispenser. Multiple reload areas may be located on a single bulk dispenser 102, e.g., with lower transfer components, e.g., multiple actuators or a conveyor moving in multiple directions. In this manner, a food item dispensed from the bulk storage environment within the dispenser 102 may be quickly distributed to a dump bin 106 or other container for prompt processing.

The dump bin 106 is movable vertically between a first location (illustrated in FIGS. 1 and 2A) and a second location (illustrated in FIG. 2B). In the first location, the dump bin 106 is configured to receive the quantity of the bulk food item from the lower transfer component 104, and as such is in a reloading position of the system 100 and dispenser 102. For example, the conveyor 112 may move bulk food items through the aperture 105 and into the dump bin 106. The dump bin 106 may then move vertically upward to a second location above the first location, for example as illustrated in FIG. 2B. In the second or raised position, the dump bin 106 is configured to dispense the quantity of the bulk food item, e.g., to an automated cooking system. The timing of the vertical move may be based on whether a receiving vessel such as a fry basket is available for dispensing. For example, the vertical movement can stop at an intermediate position until the receiving vessel is available to receive the food items at the second position. Accordingly, the second position may be a dispensing position of the system 100 and dispenser 102.

In some examples, the dispenser 102 includes a vertical stage comprising a vertical track 116 that is fixed adjacent to the lower transfer component 104 (e.g., conveyer, actuator, etc.). In the example illustrated in FIGS. 1, 2A, and 2B, the dump bin 106 is attached to the vertical track 116 such that it can be selectively raised to dispense food items to other automated components (e.g., to a basket held by a robot arm) and lowered to receive the next food items for dispensing. The dump bin 106 may move vertically, e.g., perpendicular to the ground along the vertical track 116 between positions on the vertical track 116. As shown in FIGS. 2A and 2B, respectively, the dump bin 106 may move between a first position where a height of the dump bin 106 above a floor surface is H₁ and a second position where a height of the dump bin 106 above the floor surface is H₂.

The interface between the dump bin 106 may include one or more doors, hatches, and the like that selectively open to permit dispensing from the bulk dispenser 102 to the dump bin 106, based on criteria (e.g., determined by sensors) such as the availability of food items for dispensing, location of the dump bin, location of receiving vessel, and requested food items. Although a single dump bin 106 is depicted in examples herein, multiple dump bins can be utilized, for example, by “storing” dump bins above the point of dispensing to the automated food processing component(s) (i.e., above the second position illustrated in FIG. 2B), rotating one or more dump bins 106 about the vertical track 116, or providing an adjacent staging area. In this manner, multiple dump bins 106 may provide a short term “inventory” of items for direct dispensing. In some embodiments, the staging area and/or certain dump bins 106 may provide for heating, cooling, or other desired controlled environmental characteristics of food items.

As best seen in FIG. 2B, the dump bin 106 may include a lower support for bulk food items having an automatically actuated (e.g., spring-loaded) door 118 that is actuated to dispense bulk food items within the dump bin 106. For example, the dump bin 106 may be moved along the vertical track 116 into a location in which a mechanical feature (e.g., a ramped actuation block 120 connected to the vertical stage 116) actuates the door 118 as the dump bin 106 moves vertically upward. The vertical stage 116 may be configured or instructed not to move the dump bin 106 to the location for dispensing until an associated automated cooking system is prepared to receive the quantity of a bulk food item from the dump bin 106. In the example of a robotic frying system employing a robotic arm for moving bulk food items from the dispensing system 100 to a frying medium, the system 100 may prevent the dump bin 106 from moving to the dispensing position until the robot arm has positioned a basket for receiving the quantity of the bulk food item. The spring-loaded door 118 may be actuated in other manners, such as by a plunger of the vertical track 116 actuating the door 118 manually, or a signal being provided to an internal actuation mechanism of the dump bin 106. The dump bin may include other components to facilitate dispensing to the basket (e.g., an auger, plunger, rake, etc.) which may be actuated by mechanically interfacing with the vertical track 116, or by receiving an electrical signal to actuate such components internal to the dump bin 106. Through the controlled but prompt movement of the dump bin 106 within the vertical track 116 and bulk dispenser 102, prompt and repeatable transfer from the controlled environment (e.g., within a temperature-controlled environment of the hopper(s) 108) to an automated cooking area (e.g., a robot frying station) can be assured.

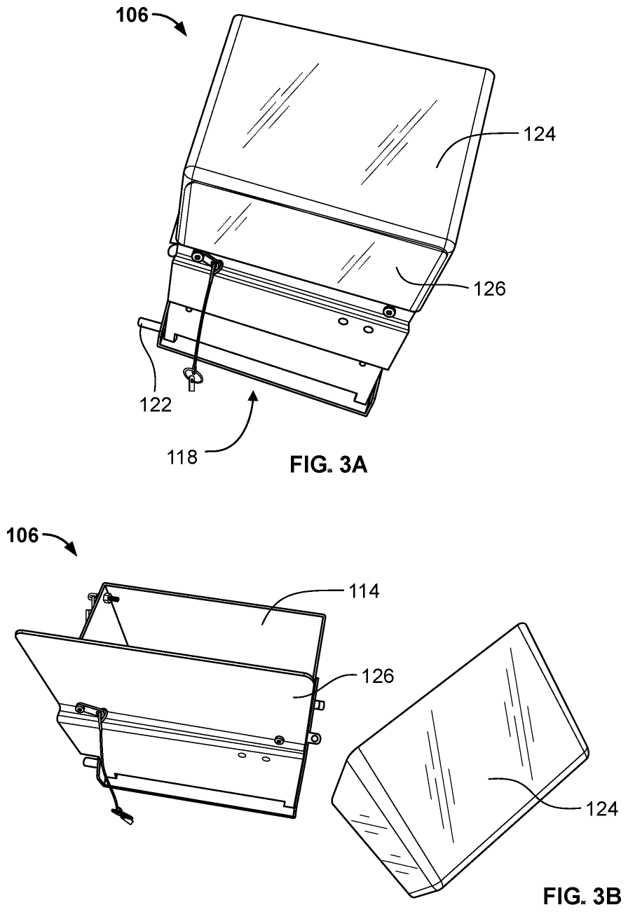

Referring now to FIGS. 3A and 3B, dump bin 106 is illustrated and described in further detail. Although a dump bin 106 can include a variety of modifications such those described herein, an exemplary dump bin 106 may be removably attachable to the vertical track 116 to facilitate switching of dump bins 116, such as for cleaning or handling of different types of food items. A dump bin deflector 124 funnels food items into the dump bin 106 (e.g., from the lower transfer component 104 and/or conveyor 112) and also guards against a person or other item getting caught in the movement of the dump bin 106 along the vertical track 116. The dump bin 106 may have an opening 114 that is configured to interface with lower transfer component 104. For example, when the dump bin 106 is positioned in the first/lowered position (see, e.g., FIG. 2A), a quantity of a bulk food item may be moved horizontally to the opening 114 of the dump bin 106, which is aligned with the aperture 105 in the dispenser 102. Additional sensors may also monitor the path of the dump bin(s) 106 on the vertical track 116, to prevent damage to users and equipment. Portions of the dump bin 106 may be perforated to facilitate the release of crumbs or other small portions of food items prior to loading them to the basket for frying. For example, bulk food items may rest on the door 118 (see FIG. 2B) when contained in the dump bin 106 and the door 118 is closed, and the door 118 may have a plurality of apertures 119 (see FIG. 2B) to provide a perforated surface. The apertures 119 of the door 118 may be sized to release crumbs or portions of a food item smaller than a predetermined size. In some embodiments a tray may catch the crumbs or small food portions that fall through the apertures 119, facilitate collection of the smaller portions or allowing for dispensing them to a storage/trash area when the dump bin 106 reaches a particular location (e.g., at the bottom of the vertical track 116).

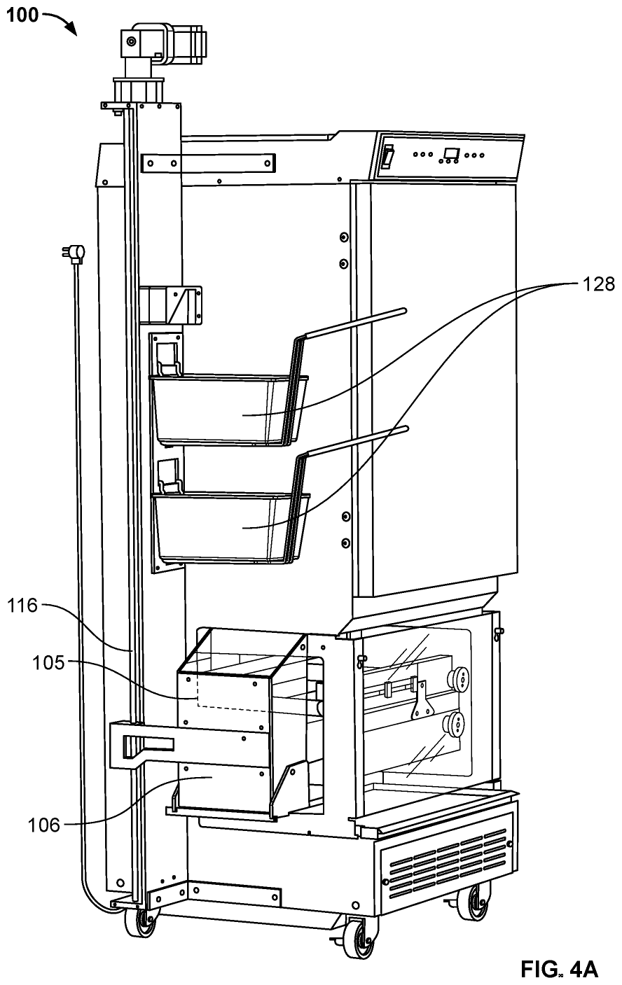

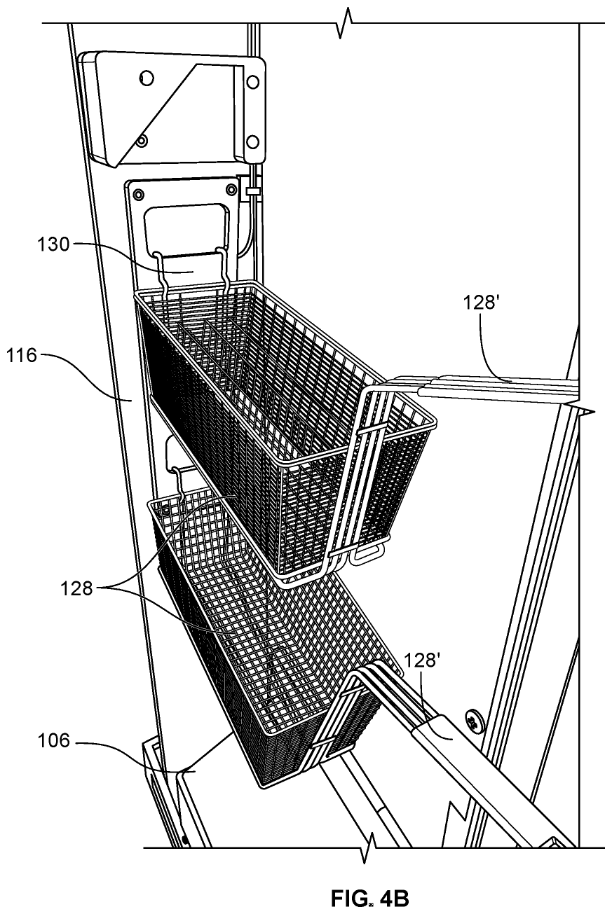

Referring now to FIGS. 4A and 4B, example illustrations are described where one or more baskets may be positioned on the vertical track 116. More specifically, the dispensing system 100 may include a plurality of baskets 128 or other receiving vessels that may be positioned on respective basket holders 130 of the vertical track 116. Furthermore, a dump bin 106 is positioned below the baskets 128 in the first position.

The basket hangers 130 may be employed in any manner that is convenient. For example, it may be desirable to create special orders that are not dispensed from the bulk dispenser 102. Such items can be facilitated such as by a user entering the zone of the bulk dispenser 102 (e.g., identified by a beacon on the user, or requested via an indicator on the system) or by baskets 128 previously stored in a location (e.g., a temperature-controlled storage bin of less used items). The user and/or robot arm may place the basket 128 on one of the basket hangers 130 of the vertical track 116, which may pause movement of the dump bin 106 along the vertical track 116 and/or cease dispensing bulk food items until the basket(s) 128 are removed, or to move via a second (e.g., adjacent, or another side of bulk dispenser) path. The baskets 128 may include mechanical and/or electrical sensors that identify the basket 128 and/or other information such as the food items in the basket and an amount thereof, order associations, and the like.

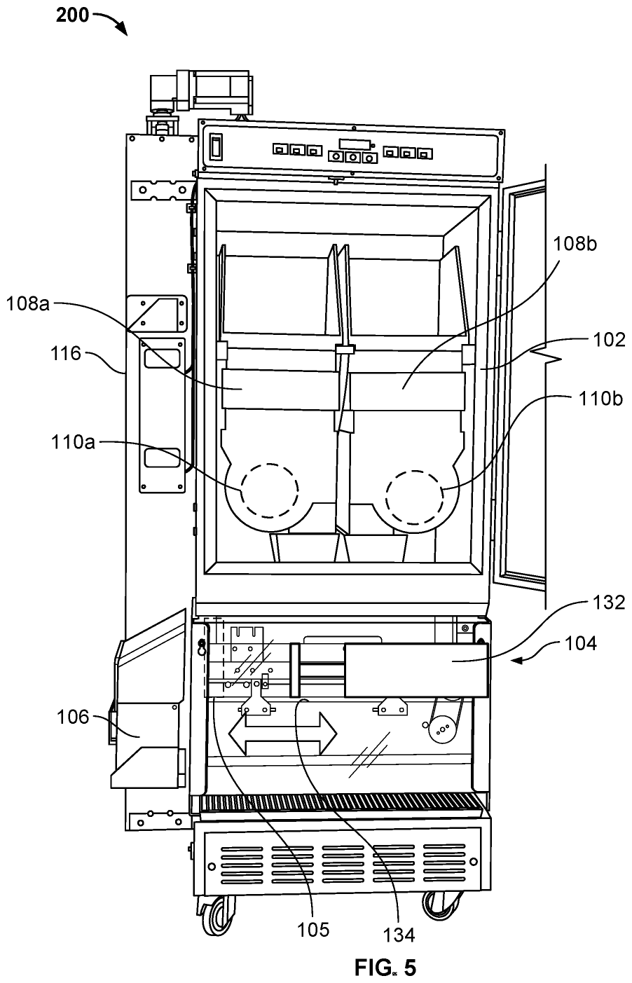

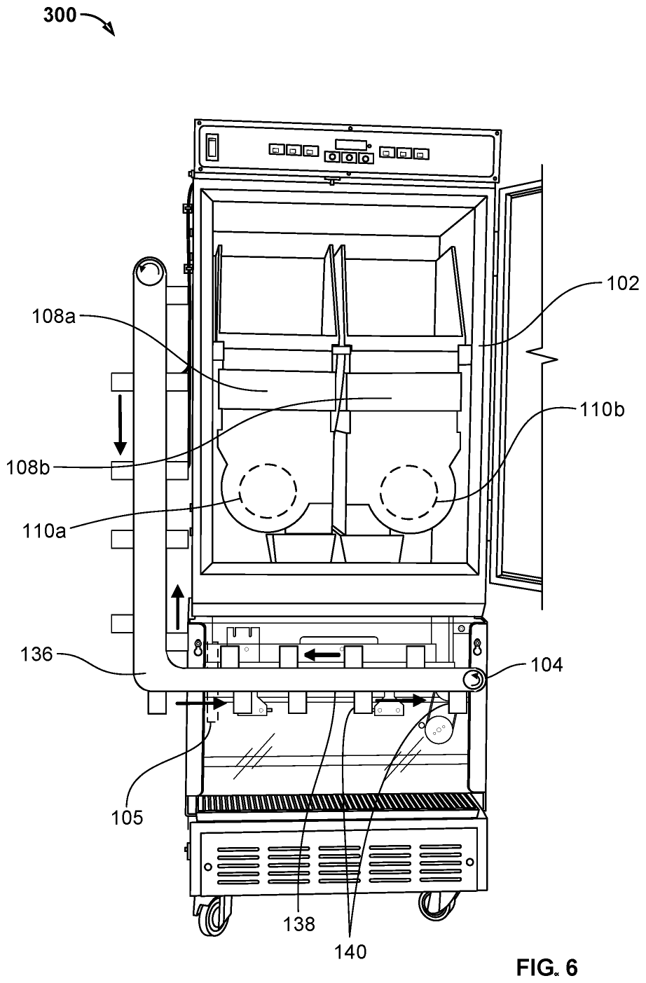

As noted above, the lower transfer component 104 may include a conveyor 112 for moving bulk food items dispensed from dispenser 102 to dump bin 106. In other examples, different mechanisms may be utilized to move the dispensed food item horizontally from the dispenser 102 to a dump bin 106 or other reload area adjacent to the dispenser 102. FIGS. 5 and 6 illustrate additional examples of mechanisms for providing bulk food items to a dump bin and/or alternatives to the dump bin. For example, the dump bin 106 can be fed by conveyors, actuators, tracks, refillable containers, or other suitable mechanisms. As described herein, the food items may be delivered from the lower dispensing location of the bulk dispenser 102 to the location for dispensing to, e.g., a robot of an automated cooking system.

As one example, in FIG. 5 a bulk food dispensing system 200 employs an actuator 132 to push bulk food items laterally to the dump bin 106. In this example, the actuator 132 may include a solenoid or other mechanism for pushing or propelling a quantity of bulk food items toward the dump bin 106 after being dispensed by the dispenser 102. The bulk food items may be dispensed onto a smooth surface below the dispenser 102 to facilitate the actuator 132 pushing the bulk food items into the dump bin 106. In another example, the surface below the dispenser 102 may be inclined.

Referring now to FIG. 6, another example bulk food dispensing system 300 is illustrated with a lower transfer component 104 comprising a continuous track 134. The ridged track 134 may include a base track 138 and a plurality of ridges or paddles 140 fixed to the base track 138 in a manner that each of the paddles 140 move with the base track 138. In other examples, a continuous track may include containers (not depicted) or components of baskets (e.g., with a mating component to a handle that is provided by the robot arm) or may otherwise dispense (e.g., pausing to locate a basket below the continuous conveyor, then resuming movement to dump the food items) to the basket. Generally, the paddles 140 or other containers may move with the base track 138 as it travels, with each paddle 140 collecting and carrying dispensed bulk food items with them as the paddle is moved around the ridged track 134. In the example illustrated, the ridged track extends horizontally below the dispenser 102 and vertically alongside the dispenser 102. The ridged track 134, in this example, may replace the dump bin 106, vertical track 116, and associated components within the lower transfer component 104, dispensing quantities of a bulk food item as the ridged track 134 moves counterclockwise. The ridged track 134 may lift quantities of bulk food items, dispensing (e.g., to a basket positioned by an automated cooking system) the quantity as the paddle 140 travels past an upper or top position of the ridged track 134, with each paddle subsequently returning downward along the ridged track 134. Accordingly, in this example approach a dump bin 106 noy not be necessary to the extent the ridged track 134 and paddles 140 may deliver quantities of a bulk food item to an elevated position, e.g., corresponding to the second position for dispensing to an automated cooking system. Alternatively, the ridged track 134 may deliver bulk food items to a dump bin 106 that moves along a vertical track 116 as described above in other example approaches.

As noted above, although in some examples a single dispenser 102 is illustrated as part of dispensing systems for bulk food items, multiple dispensers 102 may be employed where convenient. Generally, any number of dispensers 102 may be networked together to provide various types or amounts of bulk food items. Each of the dispensers 102 may dispense bulk food items to an adjacent dispenser 102 with the bulk food item ultimately reaching the dump bin 106.

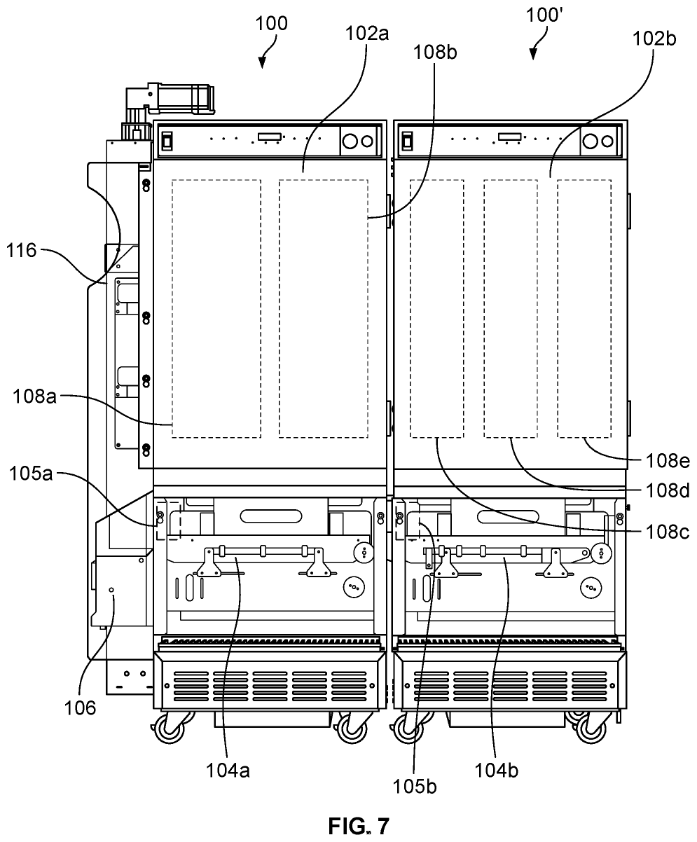

Turning now to FIG. 7, a bulk food dispensing system 100′ is illustrated comprising multiple dispensers 102a and 102b. As shown in FIG. 7, multiple dispensers 102 may be located adjacent to each other, providing a transmission path for food items from the far-right dispenser 102b to be transferred to the vertical track 116 and dump bin 106, e.g., via the lower transfer component 104 of the left side dispenser 102a located adjacent to the vertical track 116 and dump bin 106. Although a variety of lower transfer components 104 may be used in different embodiments, in an example embodiment each of the transfer components 104 of both dispensers 102 may be a conveyor 112 (e.g., a conveyor belt, a conveyor with portioned compartments, etc.). Food items from the right-side dispenser 102b may be transferred from its conveyor 112b to a conveyor 112a of the left-side dispenser 102a, and via that conveyor 112a, to the dump bin 106 and vertical track 116. In some implementations, to assist in the transfer from the conveyor 112b to conveyor 112a, the right-side conveyor 112b may have a greater height (e.g., by 1 to 4 inches) relative to a floor surface. Additionally, an appropriate feed speed of the conveyor 112b may be provided to facilitate the food items reaching the left-side conveyor 112a without requiring additional components such as a transfer station between the conveyors 112. In another example, cleated belts or a ramp incline on the conveyor 112b may propel or “launch” material up onto another conveyor. In other embodiments, a transfer station may be located between the transfer components of the respective dispensers, for example, a lateral-moving or rotating shuttle attached to either of the dispensers 102. In another example, an electro-mechanical or pneumatic pusher, or a rotary sweeping arm may be provided to facilitate movement or transfer of objects from one conveyor to another conveyor.

As depicted in FIG. 7, each of the dispensers 102a and 102b may include multiple hoppers, such as two hoppers 108a and 108b depicted for dispenser 102a and three hoppers 108c, 108d, and 108e depicted for dispenser 102b. Via the integrated transfer components and high-speed vertical dispensing via the dump bin 106, a large variety of items and combinations of items may be provided to an automated cooking systems such as a frying system. The timing of dispensing operations from each hopper to the integrated transfer system are controlled along with the dump bin motion and available fryers to supply any one of up to five types of food items in the embodiment of FIG. 7. In some embodiments, multiple dump bins can be utilized to accommodate additional throughput from the multiple dispensers, for example, by providing a horizontal staging area next to the vertical track, rotating a dump bin at a location within the vertical track to provide clearance within the vertical track for another dump bin to transit, or dumping to baskets located within basket holders that do not interfere with the vertical track.

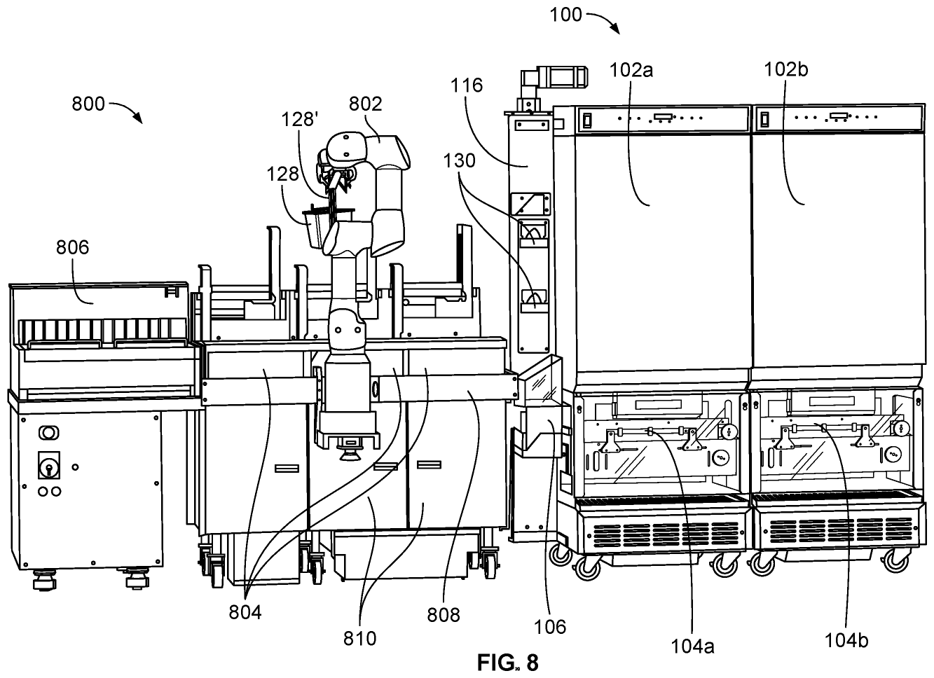

Referring now to FIG. 8, dispensing system 100 is illustrated with an automated cooking system 800. The automated cooking system 800 includes a multi-axis robot arm 802 configured to transfer quantities of bulk food items dispensed from dispensers 102 of the system 100 to fryers 804 for cooking. The automated cooking system 800 also includes holding stations 806, e.g., “crisp-and-hold” stations configured to keep cooked bulk food items such as French fries or the like warm. The holding stations 806 may also facilitate application of seasonings such as salt, pepper, or other particular seasonings that may be desired.

The dump bin 106 may move between the first and second positions described above in FIGS. 2A and 2B to facilitate dispensing of a bulk food item in desired quantities for cooking in the automated cooking system 800. Additionally, the robot arm 802 may grip baskets 128 via handles 129 and position baskets 128 below dump bin 106 after the dump bin 106 has collected a desired quantity of the bulk food item from the dispenser 102, and moved to the second or other elevated position on the vertical track 116 for dispensing from the dump bin 106. In FIG. 8, the dump bin 106 is illustrated travelling back to the first position adjacent the lower transfer component 104a of the dispenser 102a closest to the dump bin 106, with the robot arm 802 gripping a handle 128′ of basket 128 (e.g., carrying the contents received from the dump bin 106 after the dump bin 106 dispenses a quantity of bulk food items to the basket 128). The vertical track 116 may be positioned between the dispensing system 100 and the automated cooking system 800. The robot arm 802 may move a basket 128 horizontally in the direction of the dump bin 106 to receive the bulk food item contained within the dump bin 106, e.g., by the spring-loaded door 118 being opened to allow the contents of the dump bin 106 to fall into the basket 128. In this manner, the robot arm 802 does not have to perform a complicated downward articulation because of the elevated positioning of the dump bin 106. The robot 802 may thus move almost entirely within the open space above and immediately adjacent to the fryers 804. In some configurations such as that illustrated in FIG. 8, the robot arm 802 may be located on a track 808 and may be configured to move horizontally on the track 808. For example, the track 808 for the robot arm 802 may be a low friction rail that facilitates moving the robot arm 802 for moving the robot arm 802 during non-use, e.g., to allow access to cabinets 810 below the fryers 804. Accordingly, the track 808 may facilitate access to the cabinets 810 when the robot arm 802 is not moving or in use. In this manner, the robot arm 802 need not be uninstalled from the automated cooking system 800 to allow access to the cabinets 810 or other components of the automated cooking system 800 during maintenance, cleaning, etc. Accordingly, the robot arm 802 may be moved via the track 808 for positioning a basket 128 gripped by the robot arm 802 below the dump bin 106, and may subsequently return the robot arm 802 to the working area above the fryers 804, e.g., for the robot arm 802 to drop the basket(s) 128 into one of the fryers 804.

The automated cooking system 800, and in particular the robot arm 802, may move cooperatively with respect to the dump bin 106 to collect dispensed bulk food items and cook them in the fryers 804. Merely as one example, the dump bin 106 may be moving to retrieve a quantity of a bulk food item from a dispenser 102 while the robot arm 802 is performing other tasks in the automated cooking system 800, e.g., moving cooked bulk food items from a fryer 804 to a holding station 806. Accordingly, each quantity of a bulk food item may be processed or cooked relatively faster within the automated cooking system 800, particularly so when the automated cooking system 800 is in a batch mode where it is tasked with constant production of cooked bulk food items. At other times, the dump bin 106 may be in a waiting mode, e.g., while the robot arm 802 accesses manually placed baskets 128, e.g., that have been positioned on the basket holders 130 of the vertical track 116.

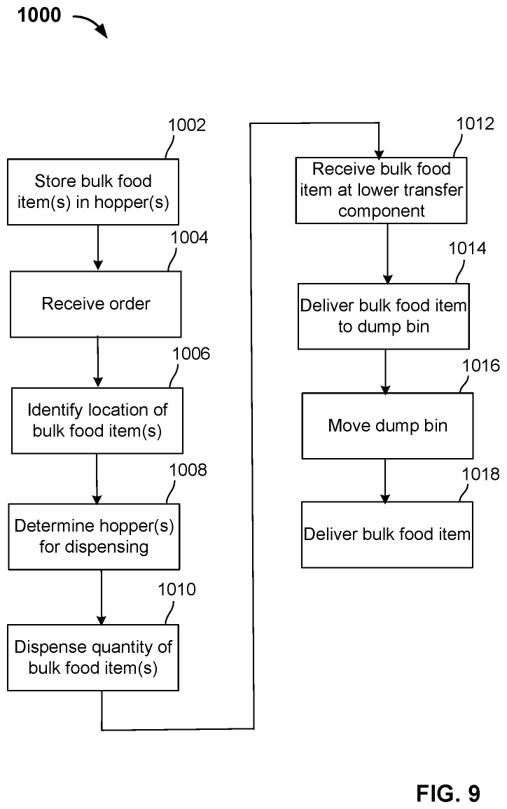

Turning now to FIG. 9, an example process 1000 is illustrated for dispensing one or more bulk food items, e.g., for an automated cooking system. Process 1000 may begin at block 1002, where one or more bulk food items may be stored within one or more hoppers, e.g., hopper(s) 108. As noted above, in some examples multiple hoppers 108 may be provided in a single dispenser 102, or in multiple dispensers 102 positioned adjacent each other. Additionally, example dispensing systems 100 may be configured with one or more baskets 128 for transferring of bulk food items from the dispensers 102 to components of an automated cooking system 800. A robotic arm of the automated cooking system 800, for example, may grip and manipulate baskets 128 to position a basket 128 to receive dispensed quantities of a bulk food item, place into a fryer 804, and transfer the quantity of bulk food items to holding station 806 after frying. Process 1000 may then proceed to block 1004.

At block 1004, an order may be received for a quantity of the stored bulk food item. For example, an order for a quantity of a bulk food item, such as one or more orders of French fries, may cause the automated cooking system 800 to generate a command to obtain a quantity of the bulk food item from the dispensing system 100. In another example, automated cooking system 800 may be placed in a “batch” mode where bulk food items are cooked as quickly as possible, e.g., during a rush of orders, peak dinner hours, etc. Process 1000 may then proceed to block 1006.

At block 1006, process 1000 may identify a location of a bulk food item to be processed in automated cooking system 800. For example, the bulk food item to be accessed may be in a particular hopper with a known location relative to the dispensing location to the dump bin, and may require transfer between transfer units (e.g., conveyors) in implementations with multiple dispensing refrigerators. Proceeding to block 1008, the dispensing system 100 may, in response to the order or command, determine a particular hopper 108 amongst a plurality of hoppers 108 in the system 100 to dispense the ordered quantity of the bulk food item. During a batch mode, for example, it may be necessary for the dispensing system 100 to switch between different hoppers 108 and/or dispensers 102. Items that receive less frequent orders may be queued based on availability of particular fryers for those items, as another example. Process 1000 may then proceed to block 1010.

At block 1010, process 1000 may cause a bulk food dispenser 102 to dispense the desired quantity of the bulk food item, e.g., by causing movement of dispensing components of a hopper 108 such as an auger 110. At block 1012, process 1000 may receive the quantity of the bulk food item at a lower transfer component 104 the bulk food dispenser 102. For example, as noted above a conveyor 112 may be provided to move the dispensed quantity of the bulk food item laterally or horizontally away from the dispenser 102 towards the dump bin, or in multi-dispenser embodiments, between transfer components to the dump bin. Proceeding to block 1014, process 1000 may deliver the quantity of the bulk food item to a dump bin 106 at a first or relatively lowered location, e.g., via an aperture in the dump bin using a later and vertical feed. Process 1000 may then proceed to block 1016.

At block 1016, once the dump bin has received all of the bulk food item, process 1000 may cause the dump bin 106 to move vertically, e.g., perpendicular to a floor surface supporting the dispensing system 100, from the first location to a second location above the first location. In some embodiments, this movement is timed and staged until the receiving vessel is available to receive the food item. In additional embodiments, a dump bin may be staged temporarily and a second dump bin may be allowed to fill and move vertically for dispensing. A vertical track 116 may be provided to facilitate movement of the dump bin 106 upward toward a second or dispensing position.

Proceeding to block 1018, process 1000 may cause the dump bin 106 to dispense or provide quantity of the bulk food item to the automated cooking system while the dump bin 106 is located at the second location. For example, as noted above a spring-loaded lower support or door may be provided that is actuated by the upward movement of the dump bin 106 and interaction with a mechanical feature of the track, allowing the contents of the dump bin 106 to be emptied into a basket 128 positioned by a robot arm 802.

In example systems and methods described above, dispensing systems may generally reduce a number or degree of movements required for a robot arm to retrieve bulk quantities of food. For example, providing or dispensing bulk food items at a relatively elevated position in comparison to typical gravity-based dispensing systems may increase overall throughput by reducing time consumed by requiring the robot arm to collect bulk food items from a lower position. Accordingly, potential bottlenecks in an automated cooking system may be reduced. Additionally, the automated cooking system has increased availability of locations for baskets (or other containers) of food items not ready for use.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications. The disclosed subject matter should not be limited to any single embodiment described herein, but rather should be construed according to the claims.

What is claimed is:

1. A method for moving a quantity of a bulk food item within an automated cooking system, comprising:
providing, from a bulk food dispenser, the quantity of the bulk food item;
receiving, at lower transfer component and from the bulk food dispenser, the quantity of the bulk food item;
transferring, from the transfer component to a dump bin at a first location, the quantity of the bulk food item;
moving the dump bin vertically from the first location to a second location above the first location; and
providing the quantity of the bulk food item to the automated cooking system while the dump bin is located at the second location.

2. The method of claim 1, wherein the bulk food dispenser includes a plurality of hoppers.

3. The method of claim 2, wherein the plurality of hoppers are located within a temperature-controlled environment.

4. The method of claim 2, wherein an auger of a first hopper of the plurality of hoppers provides the quantity of the bulk food item.

5. The method of claim 4, wherein the bulk food item is provided from the first hopper, further comprising:
receiving an instruction to switch from providing a first bulk food item from the first hopper to providing a second bulk food item from a second hopper of the plurality of hoppers; and
providing, in response to the instruction, the second bulk food item from the second hopper.

6. The method of claim 1, wherein the transfer component comprises a conveyor, and wherein the transferring comprises moving the quantity of the bulk food item horizontally to a corresponding opening of the dump bin.

7. The method of claim 1, wherein the transfer component comprises an actuator, and wherein the transferring comprises the actuator pushing the quantity of the bulk food item horizontally to a corresponding opening of the dump bin.

8. The method of claim 1, wherein the transfer component comprises ridged track, and wherein the transferring comprises the ridged track pushing the quantity of the bulk food item horizontally to a corresponding opening of the dump bin.

9. The method of claim 1, wherein the moving the dump bin vertically comprises moving the dump bin perpendicular to a floor surface along a vertical track.

10. The method of claim 9, wherein the dump bin is detachable from the vertical track.

11. The method of claim 10, wherein the dump bin includes a lower portion configured to support the quantity of the bulk food item, the lower portion defining a plurality of apertures sized to release portions of the bulk food items smaller than the apertures from the dump bin.

12. The method of claim 1, wherein the dump bin comprises a spring-loaded door, and wherein the spring-loaded door is actuated at the second location to dispense the quantity of the bulk food item.

13. The method of claim 9, further comprising receiving a basket on the vertical track.

14. The method of claim 13, further comprising accessing, by a robot arm of the automated cooking system, the basket, wherein the dump bin is paused from moving vertically while the basket is located at the vertical track.

15. The method of claim 1, wherein the automated cooking system comprises a robot arm, and wherein the quantity of the bulk food item is provided to a basket held by the robot arm.

16. The method of claim 1, wherein the bulk food dispenser is a first bulk food dispenser, the method further comprising positioning a second bulk food dispenser positioned on a first side of the first bulk food dispenser, wherein the second bulk food dispenser is configured to transfer bulk food quantities to the first bulk food dispenser at the first side of the first bulk food dispenser, and wherein the first bulk food dispenser is configured to dispense the bulk food quantities to the dump bin at a second side of the first bulk food dispenser opposite the first side.

17. A bulk food dispensing system, comprising:
a bulk food dispenser configured to store a bulk food item in a hopper, the hopper configured to dispense a quantity of the bulk food item;
a lower transfer component configured to receive the quantity of the bulk food item from the hopper and transfer the quantity of the bulk food item laterally away from the hopper; and
a dump bin configured to receive the quantity of the bulk food item from the lower transfer component at a first location, wherein the dump bin is configured to move vertically from the first location to a second location above the first location, and wherein the dump bin is configured to provide the quantity of the bulk food item to an automated cooking system while the dump bin is located at the second location.

18. The bulk food dispensing system of claim 17, further comprising a vertical track configured to move the dump bin perpendicular to a floor surface from the first location to the second location.

19. The bulk food dispensing system of claim 17, wherein the bulk food dispenser is a first bulk food dispenser configured to store a bulk food item, wherein the bulk food dispensing system comprises a second bulk food dispenser configured to store a second bulk food item, the second bulk food dispenser positioned on a first side of the first bulk food dispenser, wherein the second bulk food dispenser is configured to transfer a quantity of the second bulk food item to the first bulk food dispenser at the first side of the first bulk food dispenser, and wherein the first bulk food dispenser is configured to dispense the quantity of the second bulk food item to the dump bin from a second side of the first bulk food dispenser opposite the first side.

20. The bulk food dispensing system of claim 17, wherein the bulk food dispenser defines an aperture positioned on a first side of the bulk food dispenser and configured to receive a quantity of a second bulk food item, wherein the lower transfer component is configured to transfer the quantity of the second bulk food item laterally to the dump bin.
